(19) United States
(12) Patent Application Publication
(10) Pub. No.: US 2009/0303468 A1
(43) Pub. Date: Dec. 10, 2009

(54) Undulation Inspection Device, Undulation Inspecting Method, Control Program for Undulation Inspection Device, and Recording Medium

(75) Inventors: Kenji Itoh, Osaka (JP); Tamon Iden, Nara (JP); Takeshi Murakami, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka-shi (JP)

(21) Appl. No.: 12/308,241

(22) PCT Filed: Jun. 12, 2007
(86) PCT No.: PCT/JP2007/061841

§ 371 Date: Dec. 10, 2008

(30) Foreign Application Priority Data
Jun. 12, 2006 (JP) 2006-162891

(51) Int. Cl. G01N 21/88; G06F 19/00

(52) U.S. Cl. 356/237.2; 700/90

(57) ABSTRACT

An undulation inspection device of the present invention includes: illumination means (line light source 2) that subjects, to illumination, an object to be inspected; light intensity acquisition means (area sensor 3) that acquires light intensity distribution of light that comes, in response to the illumination, from a surface of the object to be inspected; image capturing means (line sensor 4) that obtains only predetermined light out of light that comes from the surface of the object to be inspected; adjustment means (image processing section 20 and light source drive controlling section 21) that adjusts the illumination means (line light source 2), based on the light intensity distribution that is obtained from the light intensity acquisition means; and determination means (defect determination processing means 23) that determines a state of undulation that is formed on the surface of the object to be inspected, based on a result of capturing an image by the image capturing means after adjustment of the illumination means. This makes it possible to provide an undulation inspection device capable of inspecting simply and at a high precision a state of undulation (a difference in film thickness) on a surface of a large substrate (e.g., color filter substrate).

### TECHNICAL FIELD

The present invention relates to a method of inspecting an undulation state of an object that has a subtle undulation on a surface of the object.

### BACKGROUND ART

In recent years, demands for liquid crystal display devices such as liquid crystal televisions and liquid crystal monitors have increased. Moreover, demands for cost reduction in the liquid crystal display devices have been increasing year after year. In particular, because a ratio of production cost of a color filter is high in a production cost of a liquid crystal display device, reduction in the production cost of the color filter is required.

In the color filter, when a difference of several tens of nanometers in film thickness occurs between picture elements, a difference in transmittance and/or cell gap occurs. This produces a defect such as color unevenness when the color filter is assembled into a panel. Accordingly, an inspection is carried out at the time when the color filter is completed so that a defective color filter is not supplied to a subsequent process. This is intended to improve a process yield.

Meanwhile, even if a difference of several tens of nanometers in film thickness occurs between picture elements of a color filter, a difference in transmittance between the picture elements is less than approximately 1%. In other words, luminances hardly vary between the picture elements, even when an image of directly transmitted light is captured. Accordingly, it is very difficult to detect, as a defect, the difference of several tens of nanometers in film thickness. In order to solve this problem, Patent Document 1 discloses a method of detecting linear irregularity. In this method, after a coherent light beam from a light source is divided into two, one light beam is arranged to illuminate a color filter at a substantially horizontal angle and the other light beam is arranged to be a reference light beam. Then, a reflected light beam of the color filter is arranged to interfere with the reference light beam and, from a signal showing a phase of the interference, a film thickness of the color filter is measured, so that the streaky defect is detected.
[Patent Document 1]

Japanese Unexamined Patent Publication No. 121323/2000 (Tokukai 2000-121323) (published on Apr. 28, 2000)

### DISCLOSURE OF INVENTION

However, year after year, a size of a transparent substrate (mother glass) that is used for producing a color filter is increased (for example, a square 2 m on a side) for the purpose of reducing a production cost per panel. As a result, in the technique of Patent Document 1, it becomes difficult to adjust an image sensor system so that a reflected light beam interferes with a reference light beam.

Further, it is adopted, as a method of inspecting a substrate, to inspect the substrate with the use of a visual inspection device that allows moving the substrate right and left and up and down for a review. However, a size of the visual inspection device increases as a size of the mother glass increases. Further, it is difficult to detect a difference of several tens of nanometers in film thickness through visual observation. In addition, precision of the inspection varies from person to person. These lower a process yield.

The present invention is attained in view of the above problems. An object of the present invention is to provide an undulation inspection device that allows detecting a surface undulation (a difference in film thickness) simply and at a high precision even in the case of a large size substrate (e.g., a color filter substrate) of, for example, a square 2 m on a side.

In order to solve the above problems, an undulation inspection device of the present invention that determines a state of undulation (e.g., surface undulation caused by a difference in film thickness between sections) formed on a surface of an object to be inspected, the undulation inspection device includes: illumination means that subjects, to illumination, the object to be inspected; light intensity acquisition means that acquires light intensity distribution of light that comes, in response to the illumination, from the surface of the object to be inspected; image capturing means that obtains only predetermined light out of the light that comes from the surface of the object to be inspected; adjustment means that adjusts the illumination means or the image capturing means, based on the light intensity distribution that is obtained from the light intensity acquisition means; and determination means that determines the state of undulation that is formed on the surface of the object to be inspected, based on a result of capturing an image by the image capturing means after adjustment of at least either the illumination means or the image capturing means.

According to the arrangement, the adjustment means adjusts the illumination means or the image capturing means, based on the light intensity distribution that is obtained from the light intensity acquisition means. Accordingly, the image capturing means can obtain only desired light (light suitable for determining a state of undulation) out of light that is of various intensities and comes from the surface of the object to be inspected. This makes it possible to determine simply and at a high precision a state of undulation on the surface of the object to be inspected, based on a result of obtaining the light with the use of the image capturing means. Further, because the undulation inspection device has a very simple arrangement, the undulation inspection device is suitable to an inspection of a large substrate (e.g., a color filter substrate) of a square 2 m on a side, for example.

By determining a defect of the object inspected (e.g., a color filter substrate), a feedback can be immediately given to production equipment of the object inspected. Further, only good produces can be sent to a subsequent production line. This makes it possible to improve a process yield and to reduce cost.

It is preferable that the adjustment means adjusts the illumination means or the image capturing means so that each of a specular reflection region, a diffused reflection region, and a low reflection region is identified based on the light intensity distribution and, in addition, the image capturing means can obtain light that is suitable for determining the state of undulation, that is, light in an area in a vicinity of a boundary between the diffused reflection region and the low reflection region.

It is preferable that the light intensity acquisition means includes an area sensor that obtains, in an area form, the light that comes from the surface of the object to be inspected. According to the arrangement, it becomes possible to obtain the light intensity distribution by one image capturing with the use of the area sensor. Accordingly, a tact time can be shortened.

It is preferable that the illumination means is a line light source that performs illumination in a line and the image capturing means includes a line sensor that obtains, in a line form, the light that comes from the surface of the object to be inspected. According to the arrangement, while inspection precision is ensured, a size of the device (light intensity acquisition means and image capturing means) can be reduced. Further, a tact time can be reduced.

It is preferable that the line light source employs a silicon dioxide rod. According to the arrangement, a luminance of the illumination onto the surface of the object to be inspected can be made uniform. Accordingly, inspection precision can be improved.

In the undulation inspection device of the present invention, the light that comes from the surface of the object to be inspected may be light that is reflected by the surface of the object to be inspected (that is, the illumination means may be provided on a front surface side). Alternatively, in a case where the object to be inspected has a transmissive characteristic, the light that comes from the surface of the object to be inspected may be light that transmits through the object to be inspected from a back surface to a front surface and is reflected by the surface (that is, the illumination means may be provided on a back surface side of the object to be inspected).

It is preferable that the adjustment means adjusts a relative positional relation between the illumination means and the image capturing means by moving (rotating inclusive) the illumination means or the image capturing means. According to the arrangement, the illumination means or the image capturing means is adjusted easily.

In order to solve the problem mentioned above, an undulation inspection device of the present invention that determines a state of undulation formed on a surface of an object to be inspected, the undulation inspection device includes: illumination means that subjects, to illumination, the object to be inspected; image capturing means that obtains only predetermined light out of light that comes from the surface of the object to be inspected; setting means that obtains light intensity distribution of the light that comes from the surface of the object to be inspected, by capturing an image with use of the image capturing means, while the illumination means is being moved, and sets a relative positional relation between the illumination means and the image capturing means based on the light intensity distribution; and determination means that determines a state of undulation that is formed on the surface of the object to be inspected, based on a result of capturing an image by the image capturing means after the relative positional relation is set.

According to the arrangement, the setting means adjusts the illumination means or the image capturing means based on the light intensity distribution that is obtained from the light intensity acquisition means. Accordingly, the image capturing means can obtain only desired light (light that is suitable for determining a state of undulation) out of light that is of various intensities and comes from the surface of the object to be inspected. This makes it possible to determine easily and at a high precision a state of undulation on the surface of the object to be inspected, based on a result of obtaining the desired light with the use of the image capturing means. Furthermore, because the undulation inspection device of the present invention has a very simple arrangement that does not specifically require light intensity acquisition means, a size of the device and a production cost can be reduced. Accordingly, the undulation inspection device is more suitable to an inspection of a large substrate (e.g., color filter substrate).

Here, it is preferable that the setting means sets the relative positional relation between the illumination means and the image capturing means so that each of a specular reflection region, a diffused reflection region, and a low reflection region is identified based on the light intensity distribution and, in addition, the image capturing means can obtain light in an area in a vicinity of a boundary between the diffused reflection region and the low reflection region.

It is preferable that the illumination means is a line light source that performs illumination in a line and the image capturing means includes a line sensor that obtains, in a line form, the light that comes from the surface of the object to be inspected.

It is preferable that the undulation inspection device of the present invention further includes light beam adjustment means that narrows down a light beam of the illumination light. This reduces light from positions other than a point to be observed and makes it possible to obtain light intensity distribution at a high precision. Consequently, placement of at least either the illumination means or the image capturing means can be adjusted (set) precisely. As a result, a state of undulation formed on the surface of the object to be inspected can be determined at a high precision. In this case, the light beam adjustment means may include a slit. Further, if at least one of a position and a width of the slit can be varied, illumination of a necessary intensity of light can be provided on the surface of the object to be inspected even when a position of the illumination means or the image capturing means is changed.

In order to solve the problem mentioned above, an undulation inspection method of the present invention for determining a state of undulation formed on a surface of an object to be inspected, with use of (i) illumination means that subjects, to illumination, the object to be inspected and (ii) image capturing means that obtains only predetermined light out of light that comes from the surface of the object to be inspected, the method includes the steps of: obtaining light intensity distribution of the light that comes, in response to the illumination, from the surface of the object to be inspected, by subjecting, to the illumination, the object to be inspected; adjusting the illumination means or the image capturing means, based on the light intensity distribution that is obtained in the step of obtaining the light intensity distribution; and determining the state of undulation that is formed on the surface of the object to be inspected, based on a result of capturing an image by the image capturing means after the illumination means or the image capturing means is adjusted.

It is preferable that, in the step of adjusting the illumination means or the image capturing means, the illumination means or the image capturing means is adjusted, so that each of a specular reflection region, a diffused reflection region, and a low reflection region is identified based on the light intensity distribution and, in addition, the image capturing means can obtain light in an area in a vicinity of a boundary between the diffused reflection region and the low reflection region.

A control program of an undulation inspection device, for controlling the undulation inspection device of the present invention, the control program, causes a computer to execute the steps of: calculating the light intensity distribution of the light that comes from the surface of the object to be inspected; adjusting at least either the illumination means or the image capturing means, based on the light intensity distribution; and determining the state of the undulation that is formed on the surface of the object to be inspected, based on the result of capturing the image by the image capturing means after at least the illumination means or the image capturing means is adjusted.

Further, the recording medium stores the undulation inspection program in a computer-readable manner.

As discussed above, according to the undulation inspection device of the present invention, the adjustment means adjusts the illumination means or the image capturing means based on light intensity distribution that is obtained from the light intensity acquisition means. Accordingly, the image capturing means can obtain only desired light (light suitable for determining a state of undulation) out of light that is of various intensities and comes from the surface of the object to be inspected. This makes it possible to determine easily and at a high precision a state of undulation of the surface of the object to be inspected based on a result of obtaining the desired light with the use of the image capturing means. In addition, the undulation inspection device of the present invention has a very simple arrangement. Therefore, the undulation inspection device of the present invention is suitable to an inspection of a large substrate (e.g., color filter substrate).

### BRIEF DESCRIPTION OF DRAWINGS

FIG. 1 is a diagram schematically illustrating one embodiment of an undulation inspection device of the present invention.

FIG. 2 is a block diagram illustrating the undulation inspection device as illustrated in FIG. 1.

FIG. 3 is a diagram schematically illustrating an image (an area sensor image) that is obtained, with the use of a line light source, by capturing an image of a color filter substrate by using an area sensor.

FIG. 4 is a histogram showing luminance distribution of the area sensor image.

FIG. 5 is a diagram schematically illustrating an image (an area sensor image) that is obtained, with the use of a spot light source, by capturing an image of a color filter substrate by using an area sensor.

FIG. 6 is a diagram schematically illustrating another arrangement (an arrangement in which a line light source is provided to a back surface side of the color filter substrate) of an undulation inspection device of the present invention.

FIG. 7 is a diagram schematically illustrating still another arrangement (an arrangement in which a position of a line sensor is adjusted) of an undulation inspection device of the present invention.

FIG. 8 is a block diagram illustrating the arrangement of the undulation inspection device as illustrated in FIG. 7.

FIG. 9 is a flow chart illustrating an example of a process of processing by the undulation inspection device as illustrated in FIG. 1.

FIG. 10 is a diagram schematically illustrating an image (a line sensor image) obtained by capturing an image of a color filter substrate with the use of a line sensor.

FIG. 11 is a diagram schematically illustrating still another arrangement (an arrangement in which an area sensor is not used) of an undulation inspection device of the present invention.

FIG. 12 is a block diagram illustrating the arrangement of the undulation inspection device as illustrated in FIG. 11.

(a) of FIG. 13 is a graph showing a relation between a color filter and an intensity of reflected light, for illustrating a principle of a defect determination process. (b) of FIG. 13 is a diagram illustrating a state of the color filter in the case of (a) of FIG. 13.

(a) of FIG. 14 is a graph illustrating a relation between a color filter and an intensity of reflected light, for explaining a principle of the defect determination process. (b) of FIG. 14 is a diagram illustrating a state of a color filter in the case of (a) of FIG. 14.

FIG. 15 is a graph illustrating a relation between a difference in luminance and a difference in film thickness, for explaining a principle of the defect determination process.

(a) of FIG. 16 and (b) of FIG. 16 are diagrams each schematically illustrating an arrangement of an undulation inspection device of the present invention that includes a light beam adjusting section.

FIG. 17 is a block diagram illustrating a relation in terms of control of the light beam adjusting section.

FIG. 18 is a diagram schematically illustrating an arrangement of an undulation inspection device of the present invention that includes a cylindrical lens.

FIG. 19 is a perspective view illustrating a part of an arrangement of an undulation inspection device of the present invention that includes a directional filter.

FIG. 20 is a perspective view illustrating a part of an arrangement of an undulation inspection device of the present invention that includes two directional filters.

FIG. 21 is a perspective view illustrating a directional filter whose lattice (parting strips) is adjustable.

### REFERENCE NUMERALS

1, 1x, 1y Undulation Inspection Device

2 Line Light Source

3 Area Sensor

4 Line Sensor

5 Substrate Drive Stage

6 Light Source Drive Stage

8, 8x, 8y Control Device

9 Display Monitor

10 Color Filter Substrate

19 Storage Section

20, 20x Image Processing Section

21, 21x Light Source Drive Controlling Section

22 Substrate Drive Controlling Section

23 Defect Determination Processing Section

70 Light Beam Adjusting Section

71 Slit

77 Cylindrical Lens

80 Directional Filter (Vertical Lattice)

90 Directional Filter (Horizontal Lattice)

110 Specular Reflection Region

111 Diffused Reflection Region

112 Low Reflection Region

### BEST MODE FOR CARRYING OUT THE INVENTION

An undulation inspection device of the present invention can inspect any object, as an inspection target, as long as the object has a subtle undulation on a surface. Examples of the inspection target are a color filter substrate (particularly, a color filter substrate that is formed by using an ink jet method), a semiconductor wafer on which an exposure resist is formed, and a TFT substrate. The following explains, as one embodiment of the undulation inspection device of the present invention, a case where a color filter substrate is an inspection target.

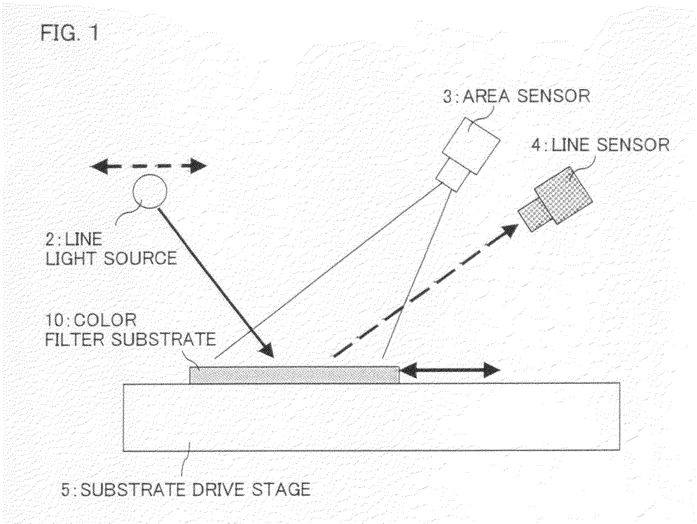

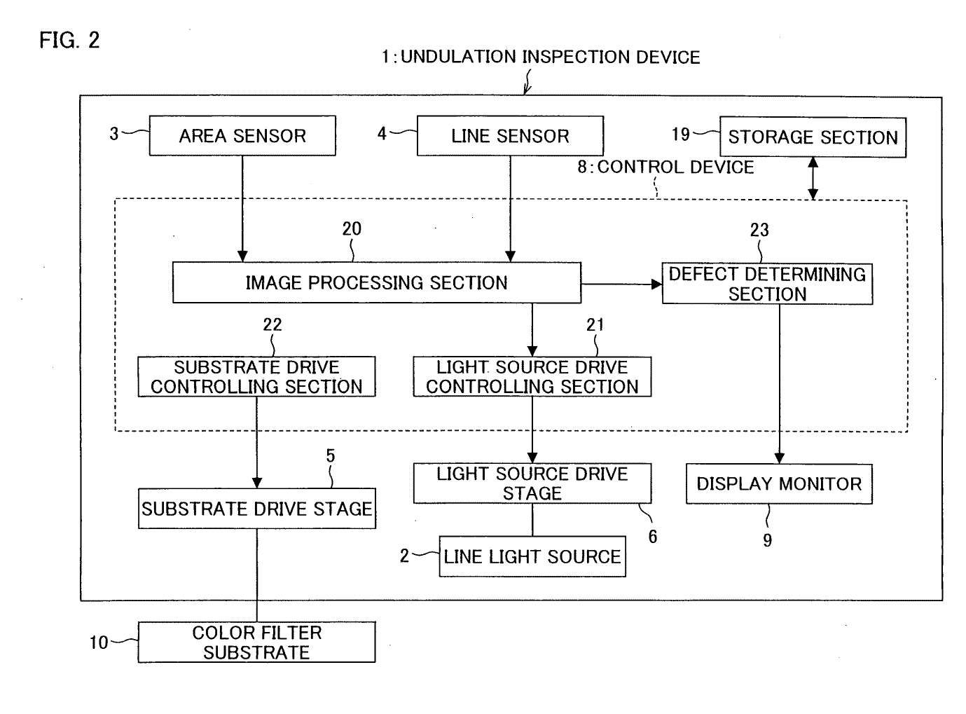

FIG. 1 is a diagram schematically illustrating a substantial part of the undulation inspection device of the present invention. FIG. 2 is a block diagram of the undulation inspection device. As shown in FIGS. 1 and 2, an undulation inspection device 1 includes a substrate drive stage 5, a line light source 2, an area sensor 3, a line sensor 4, a light source drive stage 6, a control device 8, a storage section 19, and a display monitor 9. The control device 8 includes an image processing section 20, a light source drive controlling section 21, a substrate drive controlling section 22, and a defect determination processing section 23.

The substrate driving stage 5 supports a color filter substrate 10 that is an inspection target, and moves the color filter substrate 10 in a direction along a substrate surface (a direction of an arrow in FIG. 1, hereinafter, referred to as a substrate scanning direction). The line light source 2 illuminates the color filter substrate 10 on the substrate drive state 5. It is preferable that a silicon dioxide rod is used for the line light source 2. In the silicon dioxide rod, light is totally reflected and transmitted inside the silicon dioxide rod. Accordingly, by uniformly applying a diffusion material on a rear surface of the silicon dioxide rod on a line, an outside of the silicon oxide rod can be illuminated by the light. Accordingly, as compared with a line light source of a fiber type, uniformity can be maintained. The light source drive stage 6 moves the line light source 2 to an appropriate position in a substrate scanning direction. The area sensor 3 obtains reflected light of various intensities which light is of illumination light that is emitted from the line light source 2 and reflected by a surface of the color filter substrate 10 (The area sensor 3 captures an area image of the color filter substrate 10 that is illuminated by the line light source 2). The line sensor 4 obtains predetermined reflected light of the light that is emitted from the line light source 2 and reflected by the surface of the color filter substrate 10 (The line sensor 4 captures a line image of the color filter substrate 10 that is illuminated by the line light source 2).

The substrate drive controlling section 22 drives the substrate drive stage 5 according to data from the storage section 19, and carries the color filter substrate 10 to a predetermined position. The image processing section 20 analyzes an area sensor image that is obtained from the area sensor 3 (later explained in detail). The light source drive controlling section 21 calculates an appropriate position of the line light source 2, based on (i) analysis data that is of the area sensor image and obtained by the image processing section 20 and (ii) data read out from the storage section 19 (for example, initial setting positions of the line light source 2 and the line sensor 4). Then, according to a result of the calculation, the light source drive controlling section 21 operates the light source drive stage 6. As a result, the line light source 2 is moved for a predetermined distance in a substrate scanning direction. Consequently, a relative positional relation between the line light source 2 and the line sensor 4 are set appropriately.

In response to the setting, the substrate drive controlling section 22 causes scanning of the color filter substrate 10 at a constant speed, by using the substrate drive stage 5. Simultaneously, the line sensor 4 captures an image of the color filter substrate 10. The image processing section 20 analyzes the line sensor image that is captured by the line sensor 4. The defect determination processing section 23 determines an undulation state (presence of a detect) on a surface of the color filter substrate 10, based on (i) data that is read out from the storage section 19 and (ii) analysis data that is of the line sensor image and obtained by the image processing section 20. The display monitor 9 displays a determination result (detect information) of the defect determination processing section 23, so as to allow a device administrator (an operator) to acknowledge the determination result.

It is possible to connect the control device 8 to a factory information system network (not illustrated) so that the determination result is sent to a sever that collectively manages the defect information.

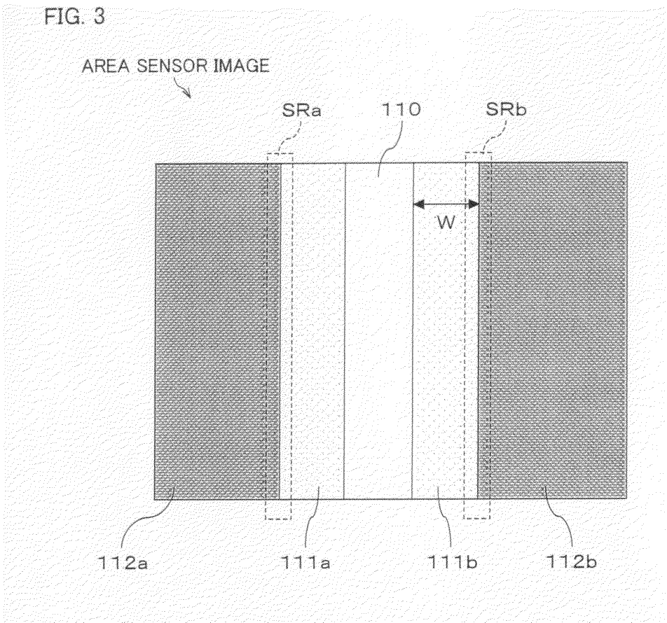

FIG. 3 schematically illustrates an image (area sensor image) of the surface of the color filter substrate 10 which image is captured by the area sensor 3. In a case where the line light source (light source in a line shape) 2 is used, the area sensor image includes, as illustrated in FIG. 3, a specular reflection light region 110, a diffused light region 111 (111a and 111b), and a low reflection light region 112 (112a and 112b). In other words, a strip-shaped region 110 (the specular reflection light region) is provided at the center. On both sides of the strip-shaped region 110, strip-shaped regions 111a and 111b (diffused reflection light regions) are provided, and strip-shaped regions 112a and 112b (low reflection light regions) are further provided on respective outer sides (on opposite sides of sides provided with the region 110) of the regions 111a and 111b.

Even if a difference in film thickness exists between the picture elements of the color filter substrate 10, a difference in luminance due to the difference in film thickness hardly appears in the specular reflection light region 110. It is very difficult to determine a difference in film thickness (defect) based on the specular reflection region 110. Meanwhile, the difference in luminance due to the difference in film thickness appears in the diffused light region 111 more significantly as a distance from the specular reflection light region 110 increases. The difference in luminance due to the difference in film thickness becomes the maximum at edge section regions SRa and SRb of the respective diffused light regions 111a and 111b. That is, by capturing an image of the edge sections SRa and SRb of the diffused light regions, it is possible to determine the difference in film thickness (a defect) simply and at a high precision.

The image processing section 20 analyzes the image (an area sensor image, see FIG. 3) that is captured by the area sensor 3, and extracts the specular reflection light region 110 and the diffused light region 111 for intensity distribution of reflected light. The following explains one example of a method of extracting the specular reflection light region 110 and the diffused light region 111.

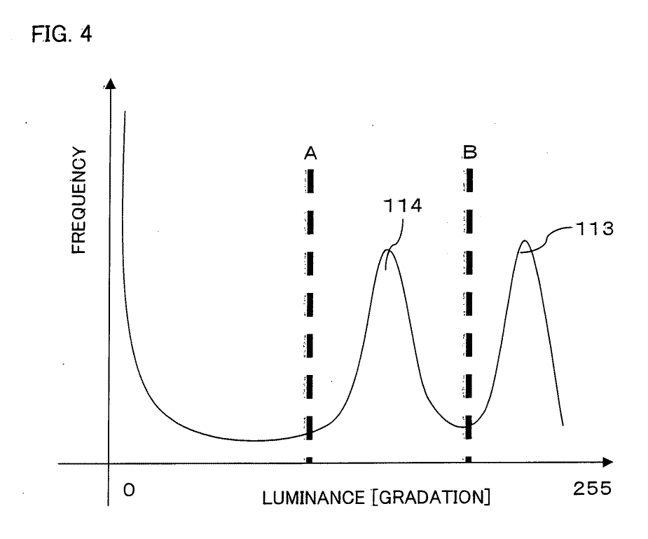

FIG. 4 is a histogram of a luminance of an area sensor image. A peak 113 in a high luminance region shows that luminance of the specular reflection light region 110 is concentrated at the peak 113. A peak 114 on a lower luminance side with respect to the peak 113 shows that luminance of the diffused light region 111 is concentrated at the peak 114. Accordingly, a threshold (luminance) A and a threshold (luminance) B are determined based on the histogram. This makes it possible to distinguish between the specular reflection light region 110 and the diffused light region 111. The threshold B can be determined according to a method such as a discriminant analysis method because there are two peaks in the histogram. It is preferable that the threshold A is set to a luminance value that makes it possible to cut light of a noise level. The luminance value is three valued in accordance with the thresholds A and B and a width W of the diffused light region (111a or 111b) is calculated in image processing.

The light source drive controlling section 21 determines an optimum position of the line light source 2 by using the width W of this diffused light region. In other words, the light source drive controlling section 21 determines a position such that an image of an edge (SRa or SRb) of the diffused. light region can be captured by the line sensor 4. The light source drive controlling section 21 also determines, from the position determined, a distance (a distance in a substrate scanning direction) for which the line light source 2 moves.

A relation between the width W of the diffused light region (111a or 111b) and the position of the line light source 2 is evaluated by using a color filter substrate 10 whose variation in film thickness is known in advance, and a database is made of conversion data between the width W and the position. Accordingly, an optimum position of the line light source 2 can be obtained, by using the conversion data in the database, from the width W of the scattered light region (111a or 111b).

Alternatively, it is possible to obtain an appropriate positional relation between the line sensor 4 and the line light source 2, by (i) measuring, with the use of no area sensor 4, intensity distribution of reflected light that illuminates the color filter substrate 10 with the use of a luminance meter, and (ii) extracting an edge section (SRa or SRb) of the diffused light region. However, in the case of using the luminance meter or the like, an error becomes large unless an incident angle is kept constant. Accordingly, it is necessary that (i) the luminance meter is moved during adjustment so that the reflected light enters the luminance meter at a constant incident angle and (ii) the intensity distribution is obtained. In consideration of this point, it is more effective for shortening a tact time to use a method in which an area sensor image is captured in a moment by the area sensor 4 and an optimum positional relation between the line sensor 4 and the line light source 2 is obtained.

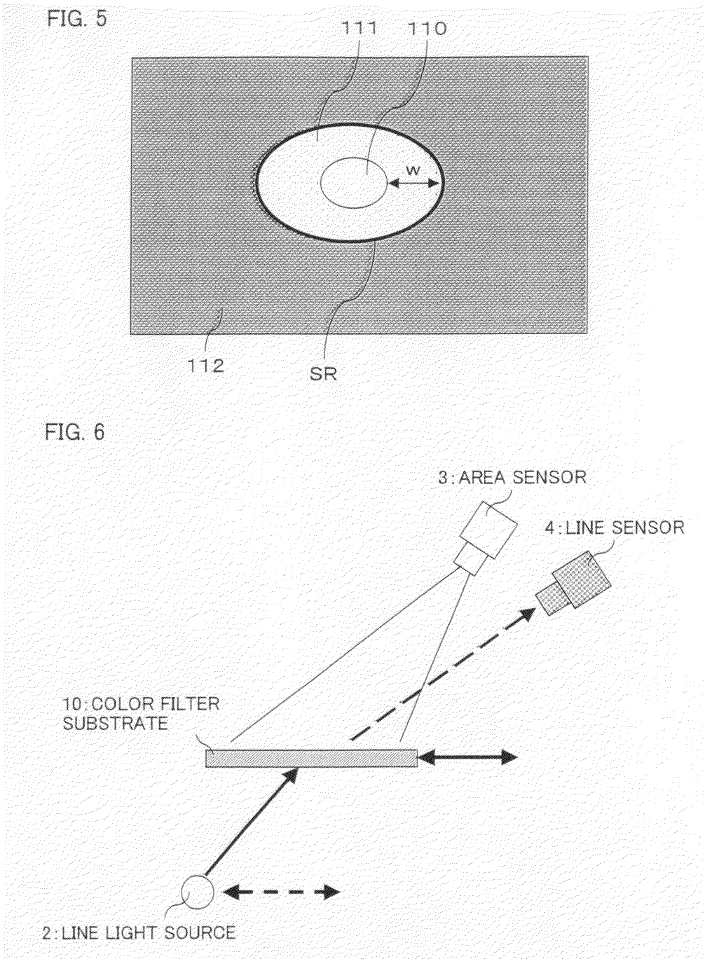

When each of the specular reflection light region 110 and the diffused light region 111 is identified and the edge section (SRa or SRb) of the diffused light region is extracted, a spot light source or the like may be used in place of the line light source (light source in a line shape). FIG. 5 shows an area sensor image (an image captured by the area sensor 3) at the time when the spot light source is used. As shown in FIG. 5, an elliptical diffused light region 111 is present on a periphery of an elliptical specular reflection light region 110. By obtaining a width w of the diffused light region in a direction in which the color filter substrate 10 is scanned, it becomes possible to determine an appropriate positional relation between the line sensor 4 and the line light source 2.

The undulation inspection device may be arranged such that the light that illuminates the color filter substrate 10 illuminates the color filter substrate 10 from a backside of the color filter substrate 10 and an image of transmitted light is captured by the area sensor 3 and the line sensor 4. FIG. 6 is a diagram schematically illustrating this arrangement. Even when the line light source 2 illuminates the color filter substrate 10 from the backside and an image of light that has transmitted the color filter substrate 10 is captured by the area sensor 3, it is possible to obtain an area sensor image as in FIG. 3, that is, to obtain an image in which a diffused light region is present on a fringe of the directly transmitted light region. Accordingly, by extracting a position of an edge section of the diffused light region, an appropriate positional relation between the light sensor 4 and the line light source 2 can be determined.

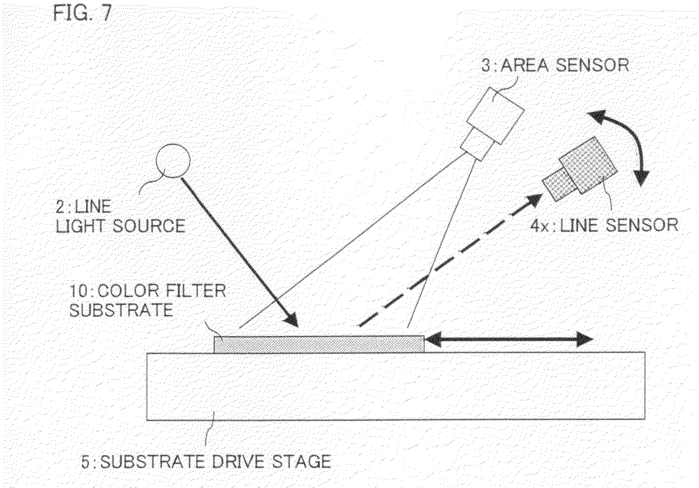

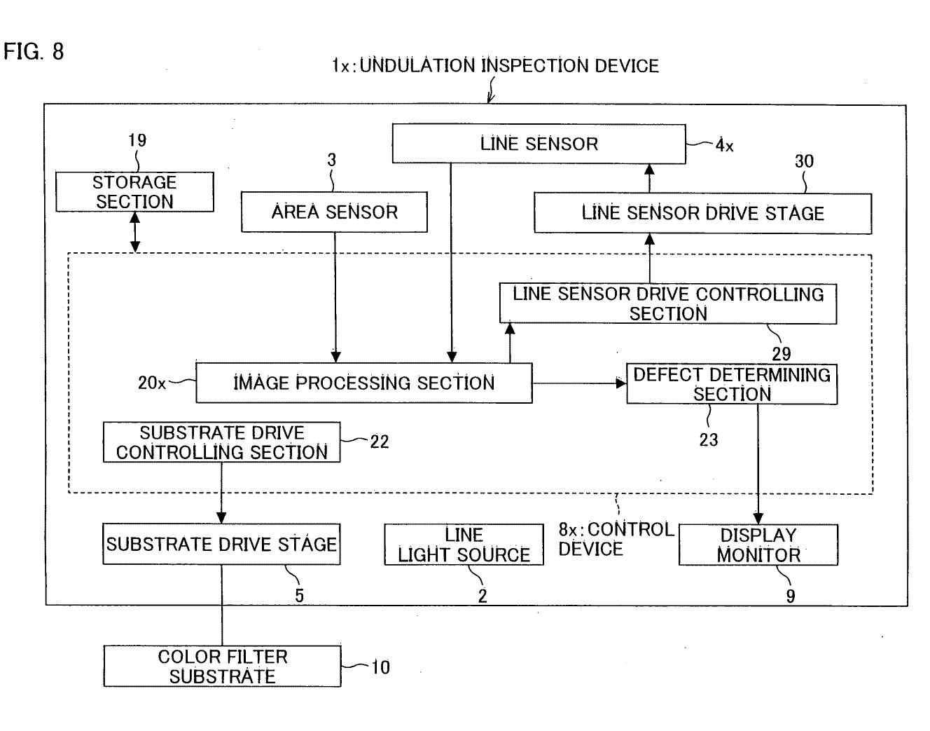

For setting a relative positional relation between the line light source 2 and the line sensor 4, an angle at which the line sensor 4 captures an image can be adjusted. FIG. 7 is a diagram schematically illustrating such an arrangement (undulation inspection device 1x). FIG. 8 is a block diagram of the arrangement. In this case, an image of a specularly reflected light is obtained when the line sensor 4 captures an image of a surface of the color filter substrate 10 at the same angle as an angle at which light enters the color filter substrate 10 from the line light source 2. In other words, a difference in luminance due to a difference in film thickness between picture elements of the color filter substrate 10 does not appear on the image. In order to solve this problem, a relation between an incident angle of the line sensor 4 and the incident angle of the light from the line light source 2 is obtained in advance from the width W of the diffused light region that is obtained by the area sensor 3. Based on this relationship, the incident angle of the line sensor 4 is determined. As a result, it becomes possible to capture an image that shows a difference in luminance due to a difference in film thickness between the picture elements of the color filter substrate 10. Specifically, an image processing section 20x of a control device 8x analyzes an area sensor image. Subsequently, the line sensor drive controlling section 29 calculates a relation between the incident angles based on a result of the analysis. Based on a result of the calculation, the line sensor drive controlling section 29 rotates a line sensor 4x into an appropriate direction by using the line sensor drive stage 30.

For setting the relative positional relationship between the line light source 2 and the line sensor 4, it is possible to move the line sensor 4 in a substrate scanning direction while the line light source 2 is kept still (as it is positioned).

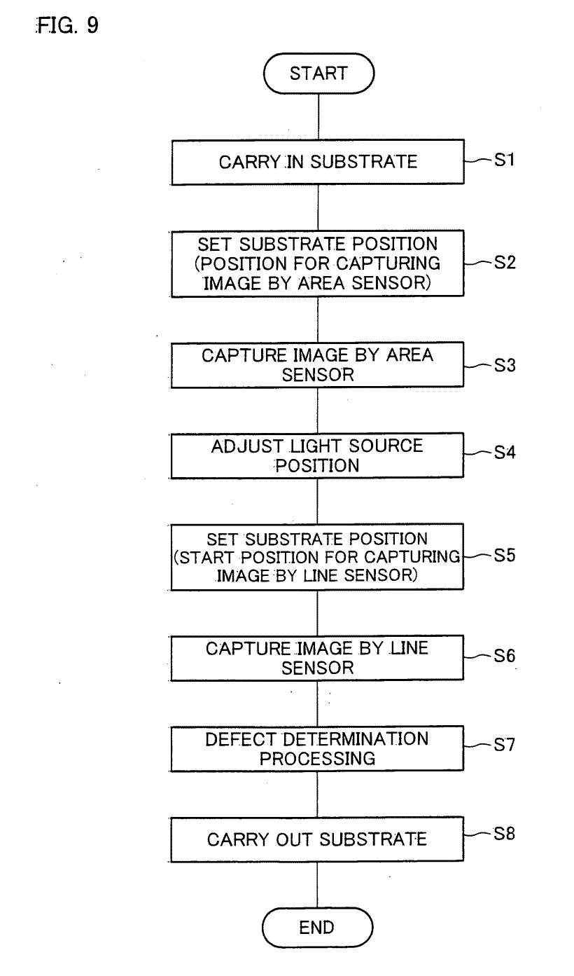

FIG. 9 is a flow chart illustrating one example of a process of processing performed by the present undulation inspection device 1.

In the process, first, a substrate carrying section (not illustrated) carries in a color filter substrate 10 into the undulation inspection device 1 (S1). This substrate carrying section transmits, to a control device 8, substrate information of the color filter substrate 10 that is carried in. The substrate information is, for example, lot information, a size of the color filter substrate 10 that is being produced, or a size of a picture element. The color filter substrate 10 is positioned on the substrate drive stage 5 that carries the color filter substrate 10. Accordingly, the control device 8 is informed of a position on which a color filter is formed.

Then, the substrate drive stage 5 moves the color filter substrate 10 to a position such that (i) light from the line light source 2 can illuminate the position on which the color filter is formed and (ii) an image of the position on which the color filter is formed can be captured by the area sensor 3 (S2). In the step S1, the control device 8 (the substrate drive controlling section 22) is informed of the position on which the color filter is formed. The substrate drive controlling section 22 operates the substrate drive stage 5 in accordance with the position and moves the color filter substrate 10 to a predetermined position (a position such that the area sensor 3 can capture an image of the position on which the color filter is formed on the color filter substrate 10). The predetermined position is stored in the storage section 19 in advance. Reading this information, the substrate drive controlling. section 22 operates the substrate drive controlling section 22 and moves the color filter substrate 10 to the predetermined position.

Further, the area sensor 3 captures an image of the color filter substrate 10. Then, the control device 8 (the image processing section 20 and the light source drive controlling section 21) calculates a distance for which the line light source 2 is to move (S3). Here, the image processing section 20 analyzes the image (area sensor image) that is captured by the area sensor 3. Based on a result of the analysis, the light source drive controlling section 21 calculates a distance (a distance in a substrate scanning direction) for which the line light source 2 is to move, so that the line sensor 4 can capture an image of the edge section 111 of the diffused light region in the area sensor image. A relative positional relationship between a position of an image of the area sensor 3 and the position at which the line sensor 4 captures an image is calculated in advance by the control device 8 or read out from the storage section 19.

Next, for causing the line sensor 4 to capture an image, the light source drive stage 6 moves the line light source 2 to an appropriate position (S4). That is, the light source drive controlling section 21 operates the light source drive stage 6 in accordance with the distance of the line light source 2 which distance is calculated in S3 by the light source drive controlling section 21.

Subsequently, as preparation for capturing an image by the line sensor 4, the substrate drive stage 5 moves the color filter substrate 10 to a start position such that the line sensor 4 starts to capture an image (S5).

Then, the line sensor 4 captures an image of the color filter substrate 10 (S6) while the line sensor 4 scans the color filter substrate 10 on the substrate drive stage 5 from the start position. While the line sensor 4 is capturing an image, the substrate drive controlling section 22 operates the substrate drive stage 5 at a constant speed. This moves the color filter substrate 10 at a constant speed. At the point when the line sensor 4 finishes capturing an image for a length of the substrate, the substrate drive controlling section 22 stops the substrate drive stage 5.

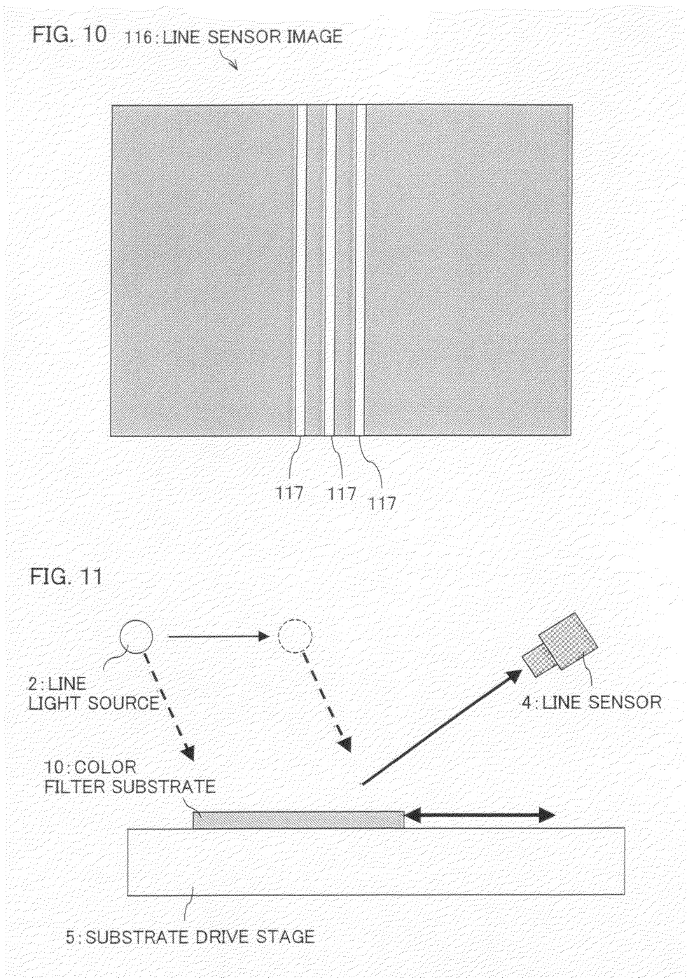

Then, the image processing section 20 analyzes a line sensor image that is captured by the line sensor 4. Based on a result of the analysis, the defect determination processing section 23 determines a defect of the color filter 10 (S7). FIG. 10 is a diagram schematically illustrating a line sensor image. In the color filter that has picture elements whose film thicknesses are different from each other by several tens of nanometers, an image of light that is reflected by a defective picture element is captured in a manner such that, due to the difference in film thickness, a luminance of the defective element is different from those of lights that are reflected by picture elements surrounding the defective picture element. That is, in a case where a film thickness of the defective picture element is larger than those of the picture elements surrounding the defective picture element, the light reflected by the defective picture element has a higher luminance. Meanwhile, in a case where the film thickness of the defective picture element is smaller than those of the picture elements surrounding the defective picture element, the light reflected by the defective picture element has a lower luminance.

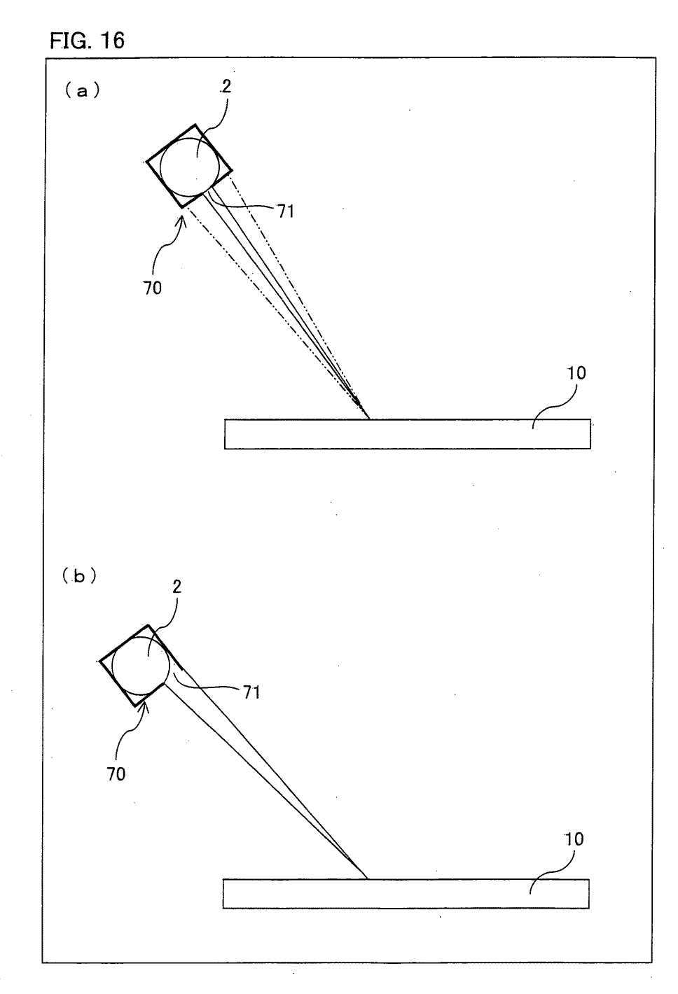

The following explains a principle in detecting a difference in film thickness of a color filter, with reference to FIGS. 13 through 15. Each of (a) and (b) of FIG. 13 shows an intensity of light reflected by a color filter surface in a case where the film thickness of the color filter is smaller than those of other color filters. Each of (a) and (b) of FIG. 14 shows an intensity of light reflected by the color filter surface in a case where the film thickness of the color filter is larger than those of other color filters. FIG. 15 is a graph showing a relation between a difference in luminance and a difference in film thickness. (b) of FIG. 14 shows a defective color filter (CF) whose film thickness has become small for some reason. When the difference in film thickness becomes smaller, an angle of gradient at a boundary surface between the color filter and a BM (black matrix) becomes smaller than those of color filters surrounding the color filter. Accordingly, as shown in (a) of FIG. 13, an intensity of light that is reflected by the color filter whose film thickness is small becomes smaller than intensities of light that are reflected by the surrounding color filters. (b) of FIG. 13 illustrates in an exaggerated manner the color filter, so as to make it easier to understand a difference in angle of gradient. Specifically, the maximum angle of gradient at a side surface of the BM is approximately one to four degrees, that is, approximately 10 μm/mm to 50 μ/mm in a slope. Meanwhile, a case where a film thickness of a defective CF is larger can be explained in a similar manner as the case where the film thickness of the defective CF is small as explained above. When the film thickness of the defective CF becomes larger, an angle of gradient of the defective CF becomes larger than those of surrounding CFs. Accordingly, as illustrated in (a) of FIG. 14, an intensity of light that is reflected by the CF whose film thickness is larger becomes larger than those of lights that are reflected by the surrounding CFs. According to this principle, the difference in film thickness (a value indicating whether the film thickness is larger or smaller than a reference film thickness) is detected as a difference in luminance of a captured image (an absolute value of a difference between an intensity of reflected light corresponding to a reference film thickness and an intensity of reflected light corresponding to a defective film thickness). Accordingly, it is possible to estimate, from a captured image, the difference in film thickness of the defective CF, by (i) capturing in advance an image of a sample whose difference in film thickness is known and (ii) evaluating in advance “a relation between a difference in film thickness and a difference in luminance of a captured image”. For example, a graph as shown in FIG. 15, that is, a graph obtained as a result of evaluating in advance a relation between the difference in film thickness and the difference in luminance may be used. By using the graph, the difference in film thickness can be easily estimated from the difference in luminance that is obtained by using the defective CF.

In a case where production equipment causes a defect (a difference in film thickness), such a defect tends to occur in each of sequential picture elements. As a result, a defect such as linear irregularity 117 is observed in a line sensor image 116 as shown in FIG. 10. In a case where the difference in film thickness between the picture elements is several tens of nanometers, a liquid crystal panel assembled becomes a defective product that has linear irregularity (problem). For extracting the streaky defect 117 more precisely (for determining a defect), it is preferable to use, as the line light source 2, a light source that employs a silicon dioxide rod. This reduces an influence of unevenness in illumination intensity. As a result, preciseness in determination of a defect is improved. It is possible to employ a fiber light source as the line light source 2.

Lastly, the color filter substrate 10 is carried out from the undulation inspection device 1 (S8). In other words, the substrate drive stage 5 moves, under a control of the substrate drive controlling section 22, the color filter substrate 10 to a position from which a substrate is carried in/out. Then, the substrate carrying section carries out the color filter substrate 10 to the outside.

As explained above, according to the undulation inspection device 1, a series of inspections of color filter substrates 10 can be automatically performed and it becomes possible to determine, easily at a high precision, whether a color filter substrate 10 is good or defective (presence of a defect). As a result, when a defective product occurs (particularly, when many defective products occur), abnormality of a color filter formation device can be immediately notified to an operator. Moreover, defect inspection information of a substrate is sent to a factory information system. As a result, only good products are sent to a subsequent process. This makes it possible to improve a process yield at the point when the color filter substrate is assembled into a liquid crystal panel. Further, in a case where defective products frequently occur at the time of producing color filter substrates it is possible to immediately make a feedback to the color filter production device.

In a case where the same relative positional relationship between the line light source 2 and the line sensor 4 is obtained for a lot unit or a machine type unit, a color filter substrate of a target lot is inputted in advance into the undulation inspection device 1 and a relative positional relationship between the line light source 2 and the line sensor 4 is controlled or changed for each lot unit or each machine type unit. This makes it possible to omit the steps S2 and S3 for subsequent color filter substrates. As a result, a tact time of the undulation inspection device 1 can be improved.

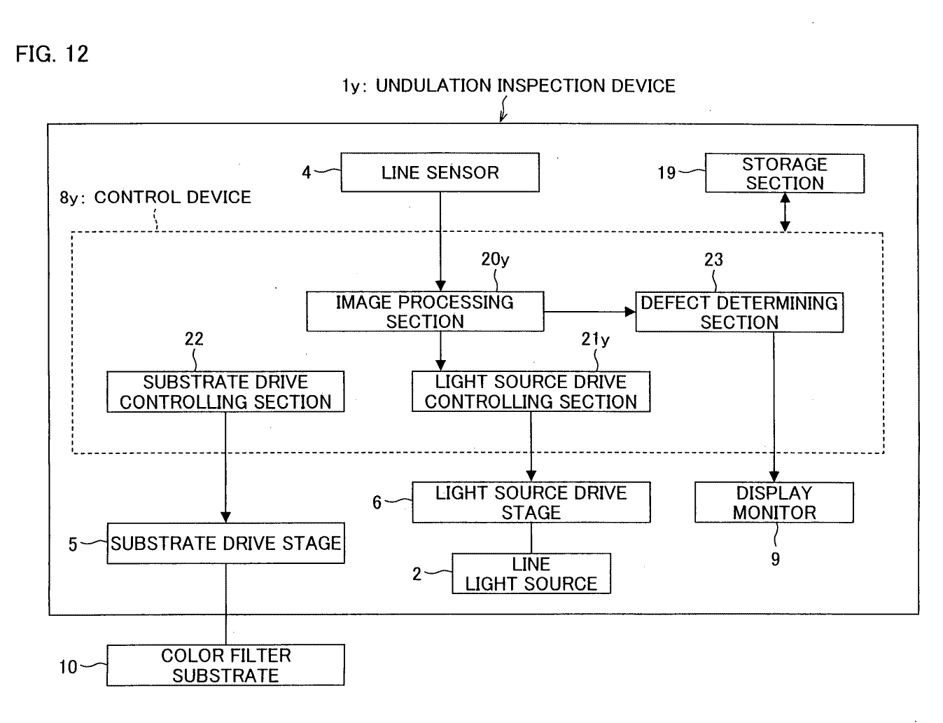

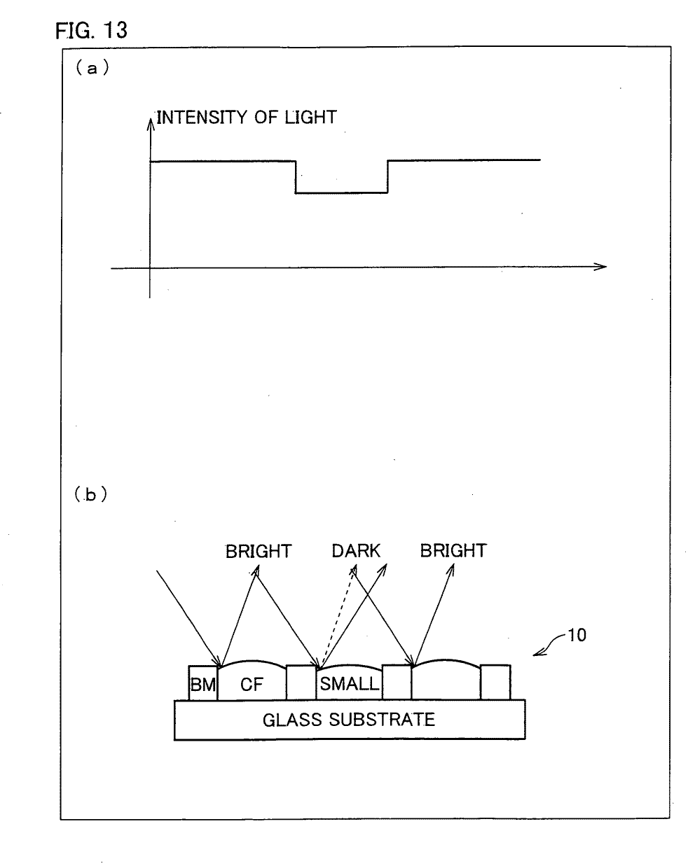

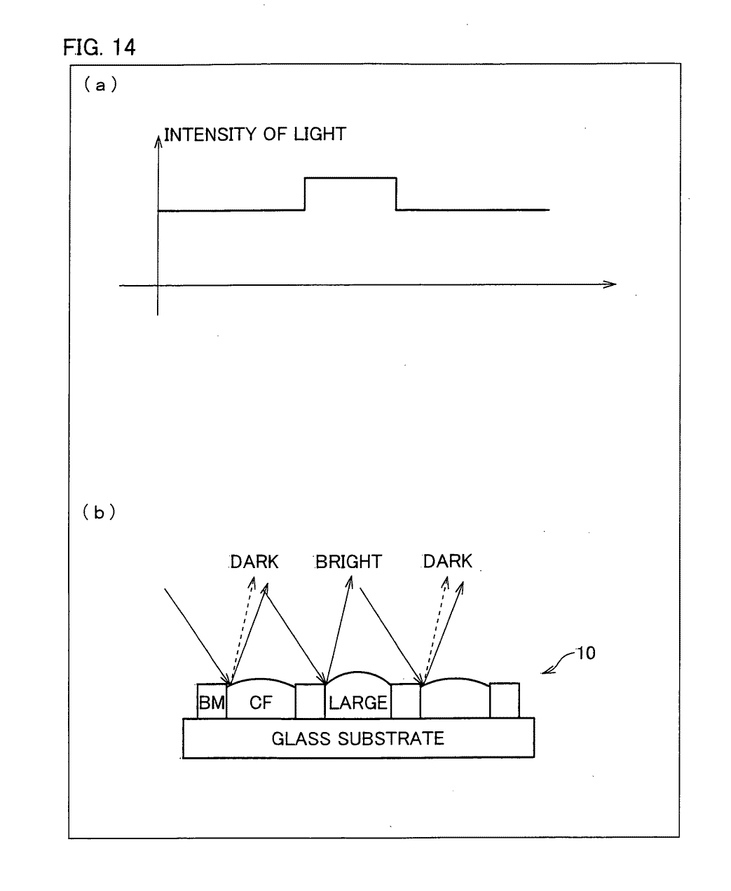

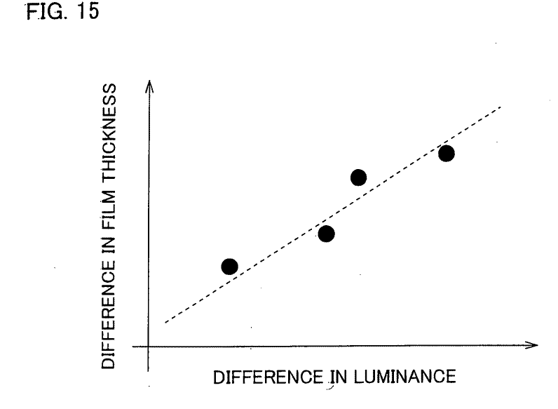

The undulation inspection device can be arranged by using no area sensor. FIG. 11 is a diagram schematically illustrating such an arrangement (an undulation inspection device 1y). FIG. 12 is a block diagram illustrating the arrangement. In other words, after S1 in FIG. 9, in place of S2 or S3, an image of the color filter substrate 10 is captured by the line sensor 4 while the line light source 2 is being moved. Specifically, while the light source drive stage 6 is moving the line light source 2 under control of the light source drive controlling section 21y, image capturing is sequentially carried out with respect to the color filter substrate 10 by the line sensor 4 so as to obtain one complete image.

This makes it possible to obtain an image identical to the area sensor image as shown in FIG. 3. Then, the control device 8 (the image processing section 20y and the light source drive controlling section 21y) calculates an appropriate position of the line light source 2. Specifically, the image processing section 20y analyzes an image that is captured by the line sensor 4, and the light source drive controlling section 21y calculates, based on a result of the analysis, a position (a position in a substrate scanning direction) of the line light source 2 in which position the line sensor 4 can capture an image of an edge section 111 of (see FIG. 3) of a diffused light region. Subsequent steps are the same as the steps from S4 in FIG. 9.

According to the arrangement, it is not necessary to provide an area sensor. It becomes possible to construct a device (system) by using only a line sensor. Accordingly, in a case where an entire surface of, in particular, a large substrate is subjected to an inspection, the arrangement is very effective because it becomes possible to easily reduce a size and a cost of the device or to make adjustment of the device easily.

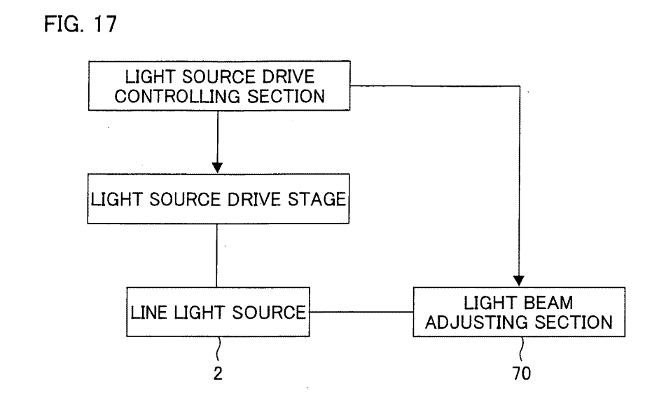

When a light beam from the line light source 2 has a large width, an image of reflected light of positions other than a point whose reflected light is to be captured is captured. Accordingly, an error tends to occur at the time when a difference in angle of gradient at a side surface of the color filter substrate is determined. Accordingly, as illustrated in (a) of FIG. 16, a light beam adjusting section 70 (light beam adjustment means) that narrows down a light beam from the line light source 2 may be provided in the arrangement as shown in, for example, FIGS. 1, 6, 7, and 11. The light beam adjusting section 70 includes a slit 71 and is provided to the line light source 2 on a side provided with the color filter substrate. This arrangement narrows down the width of the light beam as shown in (a) of FIG. 16 (see (a) of FIG. 16, a chain double dashed line in (a) of FIG. 16 indicates a light beam in a case where a slit is not provided). As a result, reflected light in positions other than a point whose image is to be captured can be restricted. This reduces an error at the time when a difference in angle of gradient (undulation state) is determined. As a result, it becomes possible to improve preciseness in defect detection. In this case, the light beam adjusting section 70 may be arranged such that a width and a position of the slit 71 are changeable. Even in a case where the line light source 2 moves, a width and a position of the slit 71 can be accordingly changed so that a necessary intensity of light can be provided at a point whose image is to be captured (see Fig. (b) of 16). The light source drive controlling section (21 and 21x) carries out control of the light beam adjusting section 70, as shown in FIG. 17.

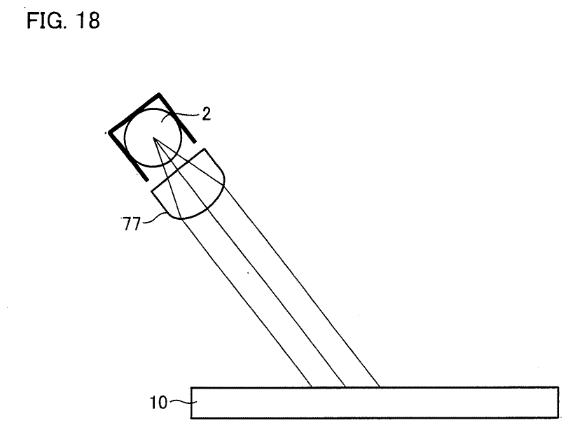

Further, a directivity may be provided to the light from the line light source 2. For example, as shown in FIG. 18, in the arrangements of FIGS. 1, 6, 7, 11, and the like, a convex cylindrical lens 77 may be provided between the line light source 2 and an observed point (a color filter substrate 10). This improves the directivity of the illumination light. Accordingly, reflected light from positions other than a point whose image is to be captured can be restricted. This improves preciseness in defect detection. The light illuminating the observed point (the color filter substrate 10) is not necessarily be a parallel light, but may be a light that slightly converges towards the observed point.

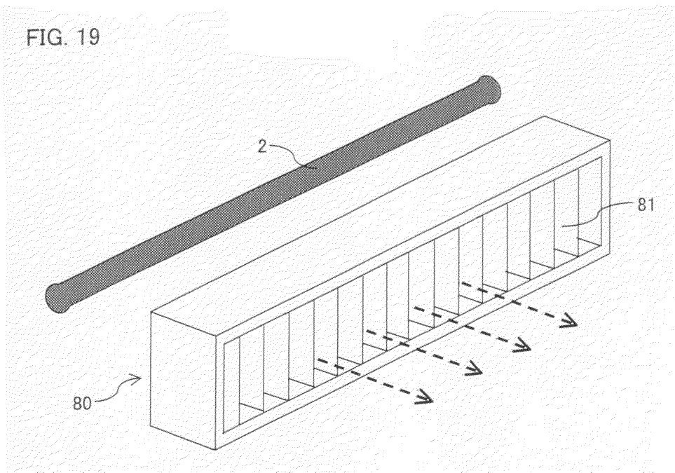

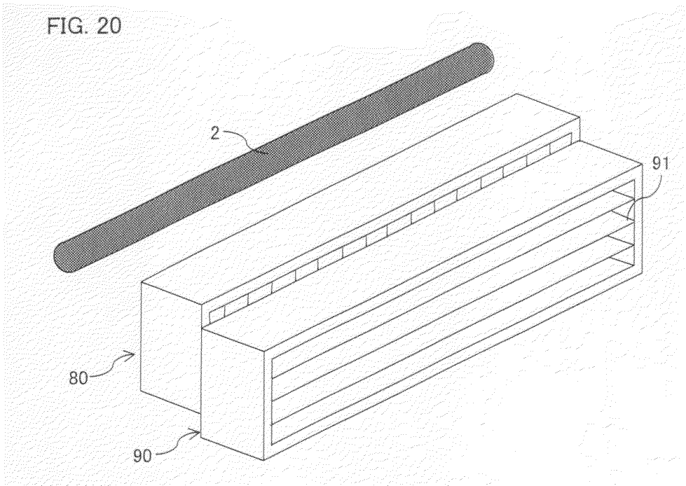

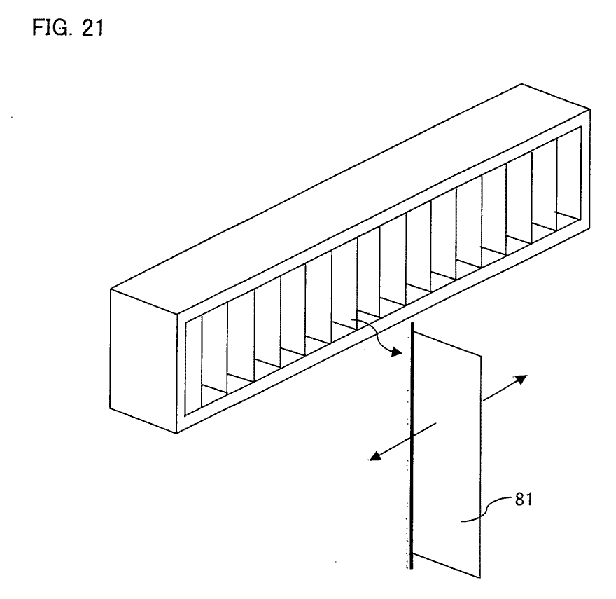

As illustrated in FIG. 19, in the arrangements of FIGS. 1, 6, 7, 11, and the like, the directivity of the illumination light may be improved by providing a directional filter 80 (directivity adjustment means) to the line light source 2 on a side provided with the color filter substrate. A frame of the filter directional 80 has an arrangement provided with a lattice (vertical lattice) 81 that is perpendicular to a direction in which the line light source extends (line direction). By providing the vertical lattice (parting strips perpendicular to a line direction) 81 in this way, the directivity of the light source light in the line direction improves. As a result, it becomes possible to restrict reflected light in positions other than a point whose image is to be captured. This can improve preciseness in defect detection. Alternatively, as shown in FIG. 20, on the directional filter 80 that has the vertical lattice 81, a directional filter 90 that has a horizontal lattice (parting strips in the line direction) 91 may be overlapped. This improves directivities in both the line direction and a direction perpendicular to the line direction. As a result, preciseness in defect detection can be further improved. As a further alternative, as shown in FIG. 21, the vertical lattice (parting strips) 81 may be arranged to be movable (for example, movability in the line direction) so that an angle of light that has passed through the directional filter 80 can be controlled. It is clear that an angle at which the directional filter 80 is placed may be changed so that an angle of the light that has passed through the directional filter 80 can be controlled.

For adjusting the light beam of the illumination light or to give the illumination light a directivity, a transmissive liquid crystal panel may be provided between the line light source 2 and the observed point (color filter substrate 10). For example, a liquid crystal panel on which a slit is displayed functions the same as the light beam adjusting section (see (a) and (b) of FIG. 16). Because what is provided is the liquid crystal panel, a layout of the slit (display) or a width of the slit is freely changed.

The display device 8 (8x or 8y) may be constituted by hardware logic or may be realized by software by using a CPU in the following manner. That is, the display device 8 (8x or 8y) includes a CPU (central processing unit) that executes the order of a control program (a control program of the undulation inspection device) for realizing the aforesaid functions (each function of each section inside the control device), and the storage section 19 includes an ROM (read only memory) that stores the control program, a RAM (random access memory) that develops the control program in an executable form, and a storage device (storage medium, recording medium), such as a memory, that stores the control program and various types of data therein. With this arrangement, the object of the present invention is realized by a predetermined storage medium. The storage medium stores, in a computer-readable manner, program codes (executable code program, intermediate code program, and source program) of the undulated inspection program, which is software for realizing the aforesaid functions. The storage medium is provided to the undulation inspection device 1. With this arrangement, the undulation inspection device 1 (alternatively, CPU or MPU) as a computer reads out and executes the program code stored in the storage medium provided.

The storage medium to supply the program code may be, for example, a floppy® disc, a hard disk, an optical disk, an optical magnetic disk, a magnetic tape, or an involatile memory card.

In a case where the present invention is applied to the storage medium, a program code corresponding to the flow chart above explained is stored in the storage medium.

The present invention is not limited to the embodiment discussed in the foregoing detailed explanation. The embodiment may be applied in many variations within the scope of the claims set forth below. The technical scope of the present invention also encompasses any embodiments obtained by combining as appropriate technical means disclosed.

### INDUSTRIAL APPLICABILITY

The undulation inspection device of the present invention is capable of easily inspecting a slight undulation state on a surface of an object. Accordingly, the present invention is suitably applied to a surface inspection of, for example, a color filter substrate (in particular a substrate that is formed by using an ink jet method), a semiconductor wafer on which an exposure resist is formed, or a TFT substrate.

1. An undulation inspection device that determines a state of undulation formed on a surface of an object to be inspected, the undulation inspection device comprising:
illumination means that subjects, to illumination, the object to be inspected;
light intensity acquisition means that acquires light intensity distribution of light that comes, in response to the illumination, from the surface of the object to be inspected;
image capturing means that obtains only predetermined light out of the light that comes from the surface of the object to be inspected;
adjustment means that adjusts at least either the illumination means or the image capturing means, based on the light intensity distribution that is obtained from the light intensity acquisition means; and
determination means that determines the state of undulation that is formed on the surface of the object to be inspected, based on a result of capturing an image by the image capturing means after adjustment of at least either the illumination means or the image capturing means.

2. The undulation inspection device as set forth in claim 1, wherein:
the adjustment means adjusts the illumination means or the image capturing means so that each of a specular reflection region, a diffused reflection region, and a low reflection region is identified based on the light intensity distribution and, in addition, the image capturing means can obtain light in an area in a vicinity of a boundary between the diffused reflection region and the low reflection region.

3. The undulation inspection device as set forth in claim 1, wherein:
the light intensity acquisition means includes an area sensor that obtains, in an area form, the light that comes from the surface of the object to be inspected.

4. The undulation inspection device as set forth in claim 1, wherein:
the illumination means is a line light source that performs illumination in a line and the image capturing means includes a line sensor that obtains, in a line form, the light that comes from the surface of the object to be inspected.

5. The undulation inspection device as set forth in claim 1, wherein:
the illumination means employs a silicon dioxide rod.

6. The undulation inspection device as set forth in claim 1, wherein:
the light that comes from the surface of the object to be inspected is light that is reflected by the surface of the object to be inspected.

7. The undulation inspection device as set forth in claim 1, wherein:
the object to be inspected has a transmissive characteristic; and
the light that comes from the surface of the object to be inspected is light that transmits through the object to be inspected from a back surface to a front surface and is reflected by the surface.

8. The undulation inspection device as set forth in claim 1, wherein:
the adjustment means adjusts a relative positional relation between the illumination means and the image capturing means by moving the illumination means or the image capturing means.

9. An undulation inspection device that determines a state of undulation formed on a surface of an object to be inspected, the undulation inspection device comprising:
illumination means that subjects, to illumination, the object to be inspected;
image capturing means that obtains only predetermined light out of light that comes from the surface of the object to be inspected;
setting means that obtains light intensity distribution of the light that comes from the surface of the object to be inspected, by capturing an image with use of the image capturing means while the illumination means is being moved, and sets a relative positional relation between the illumination means and the image capturing means based on the light intensity distribution; and
determination means that determines a state of undulation that is formed on the surface of the object to be inspected, based on a result of capturing an image by the image capturing means after the relative positional relation is set.

10. The undulation inspection device as set forth in claim 9, wherein:
the setting means sets the relative positional relation between the illumination means and the image capturing means so that each of a specular reflection region, a diffused reflection region, and a low reflection region is identified based on the light intensity distribution and, in addition, the image capturing means can obtain light in an area in a vicinity of a boundary between the diffused reflection region and the low reflection region.

11. The undulation inspection device as set forth in claim 9, wherein:
the illumination means is a line light source that performs illumination in a line and the image capturing means includes a line sensor that obtains, in a line form, the light that comes from the surface of the object to be inspected.

12. An undulation inspection method for determining a state of undulation formed on a surface of an object to be inspected, with use of (i) illumination means that subjects, to illumination, the object to be inspected and (ii) image capturing means that obtains only predetermined light out of light that comes from the surface of the object to be inspected, the method comprising the steps of:
obtaining light intensity distribution of the light that comes, in response to the illumination, from the surface of the object to be inspected by subjecting, to the illumination, the object to be inspected;
adjusting the illumination means or the image capturing means, based on the light intensity distribution that is obtained in the step of obtaining the light intensity distribution; and
determining the state of undulation that is formed on the surface of the object to be inspected, based on a result of capturing an image by the image capturing means after the illumination means or the image capturing means is adjusted.

13. The undulation inspection method as set forth in claim 12, wherein:
in the step of adjusting the illumination means or the image capturing means, the illumination means or the image capturing means is adjusted, so that each of a specular reflection region, a diffused reflection region, and a low reflection region is identified based on the light intensity distribution and, in addition, the image capturing means can obtain light in an area in a vicinity of a boundary between the diffused reflection region and the low reflection region.

14. The undulation inspection device as set forth in claim 1 or 9, further comprising:
light beam adjustment means that narrows down a light beam of the illumination light.

15. The undulation inspection device as set forth in claim 14, wherein:
the light beam adjustment means includes a slit.

16. The undulation inspection device as set forth in claim 15, wherein:
at least one of a position and a width of the slit can be varied.

17. A control program of an undulation inspection device for controlling the undulation inspection device as set forth in claim 1, the control program causing a computer to execute the steps of:
calculating the light intensity distribution of the light that comes from the surface of the object to be inspected;
adjusting at least either the illumination means or the image capturing means, based on the light intensity distribution; and
determining the state of the undulation that is formed on the surface of the object to be inspected, based on the result of capturing the image by the image capturing means after at least the illumination means or the image capturing means is adjusted.

18. A computer-readable recording medium storing the control program of the undulation inspection device as set forth in claim 17.
